(19) United States
(12) Patent Application Publication
(10) Pub. No.: US 2026/0336577 A1
(43) Pub. Date: Oct. 29, 2026

(54) METHOD FOR CONTROLLING, BY MEANS OF CLOSED-LOOP CONTROL, A FORCE PROVIDABLE BY MEANS OF AN ELECTROMECHANICAL ACTUATOR

(71) Applicant: Robert Bosch GmbH, Stuttgart (DE)

(72) Inventors: Daniel Stuemke, Murrhardt (DE); Simon Peter, Weil Der Stadt (DE)

(21) Appl. No.: 19/576,198

(22) Filed: Mar. 24, 2026

(30) Foreign Application Priority Data
Apr. 28, 2025 (DE) 10 2025 116 219.0

(51) Int. Cl. B60T 8/172

(52) U.S. Cl. CPC B60T 8/172

(57) ABSTRACT

A method for controlling, using closed-loop control, a force providable using an electromechanical actuator having an electric motor. The method includes: generating an initial control signal that corresponds to a deviation between a target force and an actual force ascertained using a first adder of a force control loop; inputting the initial control signal into a phase-locked loop of the force control loop; generating an actuator control signal by adding a time-varying second control signal output by an oscillator of the phase-locked loop to the initial control signal by means of a second adder of the phase-locked loop; controlling the electromechanical actuator using the actuator control signal; ascertaining a phase difference between the actuator control signal and a rotor position of the electric motor using a phase comparator of the phase-locked loop; supplying a phase difference signal output by the phase comparator a phase controller of the phase-locked loop.

### CROSS REFERENCE

The present application claims the benefit under 35 U.S.C. § 119 of Germany Patent Application No. DE 10 2025 116 219.0 filed on Apr. 28, 2025, which is expressly incorporated herein by reference in its entirety.

### FIELD

The present disclosure relates to a method for controlling, by means of closed-loop control, a force providable by means of an electromechanical actuator.

### BACKGROUND INFORMATION

Electromechanical actuators are used in numerous technical fields, such as actuators in vehicle braking systems. In this regard, a force is generated by means of an electromechanical actuator, which force presses brake pads against a brake drum or a brake disk.

The issue of suitable sensors or methods for ascertaining the actuation force is not yet resolved for electromechanical brakes. Existing (conditionally suitable) approaches include path-based methods, wherein the relationship is exploited between clamping/spreading force and the rotor position of a servomotor, such as a brushless DC motor. One disadvantage of this approach is inter alia that the pad stiffness, the state of wear and other influences such as thermal expansion in the brake drum significantly affect the relationship between force (clamping/spreading force) and rotor position (i.e., path).

Furthermore, these influences cannot be modeled or measured with sufficient accuracy, or only with increased effort. The installation of sensors for direct force measurement is associated with significantly increased effort due to the stressful environmental influences in the brake (contamination, temperature, vibration, etc.) and is therefore not preferred.

In order to estimate the force based on the current supplied by the servomotor based on a model, precise knowledge of the model structure and model parameters, which describe, for example, friction losses in gear stages or at bearings, is necessary. The model formulation and the ascertainment of parameter values is complex and can require additional sensors. Furthermore, parameters during operation (e.g., temperature-dependent) can vary, which can negatively affect the accuracy and reliability of a model-based estimate.

### SUMMARY

An object of the present disclosure is to provide a solution to the problems described above.

This object may be achieved in a first aspect by a method for controlling, by means of closed-loop control, a force providable by means of an electromechanical actuator having an electric motor. According to an example embodiment, the method comprises:
generating an initial control signal that corresponds to a deviation between a target force and an actual force ascertained by means of a first adder of a force control loop,
inputting the initial control signal into a phase-locked loop of the force control loop, which comprises:
   a second adder,
   the electromechanical actuator,
   a phase comparator,
   a phase controller and
   an oscillator,
wherein the method further comprises:
generating an actuator control signal by adding a time-varying second control signal output by the oscillator to the initial control signal by means of the second adder,
controlling the electromechanical actuator by means of the actuator control signal,
ascertaining a phase difference between the actuator control signal and a rotor position of the electric motor by means of the phase comparator,
supplying a phase difference signal output by the phase comparator and corresponding to the phase difference to the phase controller which is designed to generate an oscillator control signal on the basis of the phase difference signal,
supplying the oscillator control signal to the oscillator which is designed to generate the time-varying second control signal on the basis of the oscillator control signal, and
generating a signal corresponding to an actual force on the basis of the oscillator control signal and supplying the signal to the first adder.

The problems of conventional methods discussed above can be solved with the method according to the present disclosure, since:
no force sensors are required, which are generally only mountable with increased effort,
no detailed model of the electromechanical actuator is required, and
the method is not affected by a change in a force-displacement relationship, for example due to temperature or wear.

The signal corresponding to an actual force can be generated, for example, on the basis of a lookup table, i.e., a table of values in which a unique relationship between the oscillator control signal and force is stored. This relationship can be ascertained in advance (e.g., directly measured) and stored, and is therefore also independent of a model of the electromechanical actuator.

In order for there to be a well-defined phase difference between the rotor position and the actuator control signal, it can also be provided that the second control signal is a periodic signal, e.g., a sinusoidal signal.

The phase controller is designed to control, by means of closed-loop control, the phase difference to a predetermined phase difference which corresponds to a specific oscillator control signal. The oscillator control signal, in turn, corresponds to a specific frequency, which has a signal generated by the oscillator. In order to be able to ensure a high degree of robustness against parameter variations of the actuator or an actuator system comprising the actuator, it can be provided that the oscillator control signal corresponds to a natural frequency of the electromechanical actuator or of the actuator system.

If the frequency of the second control signal, i.e., the excitation frequency, corresponds to the undamped natural frequency of the actuator system, the phase difference between rotor position and the actuator control signal is one quarter of a period (i.e. 90° or π/2). The phase controller can be designed to control, by means of closed-loop control, the phase difference to a quarter of a period. This allows the excitation frequency to be controlled to the undamped natural frequency.

The method according to the present disclosure can be used in applications that require a precise motor position signal, such as in steering systems. Furthermore, the method can be used to control, by means of closed-loop control, a braking force in an electromechanical braking system, wherein the electromechanical actuator is part of an electromechanical vehicle brake.

In a second aspect of the present disclosure, a computer program is provided which comprises commands that, when the computer program is executed by a computer, cause the computer to carry out a method described above.

In a third aspect of the present disclosure, a computer-readable storage medium is provided on which a computer program according to the second aspect is stored.

In a fourth aspect of the present disclosure, a vehicle braking system is provided which comprises: one or more electromechanical brakes as well as one or more open-loop/closed-loop control devices that are designed to carry out closed-loop control according to a method described above.

The vehicle braking system can have a central open-loop/closed-loop control device that is designed to control, by means of open-loop/closed-loop control, a plurality of the electromechanical brakes or all of the electromechanical brakes.

In a fifth aspect of the present disclosure, a vehicle is provided which has a vehicle braking system according to the fourth aspect.

The present disclosure is explained in more detail below with reference to the figures.

### BRIEF DESCRIPTION OF THE DRAWINGS

FIG. 1 is a schematic representation of an exemplary vehicle with an electromechanical vehicle braking system.

FIG. 2 is a schematic representation of an example closed control loop for controlling a force providable by means of an electromechanical actuator.

FIG. 3 are graphical representations that show the time progression of an actuator control signal, a rotor position and an actuation force during the execution of the method according to an example embodiment of the present disclosure.

FIG. 4 is an exemplary flowchart of an exemplary method according to the present disclosure.

### DETAILED DESCRIPTION OF EXAMPLE EMBODIMENTS

As mentioned at the outset, the method according to the present disclosure can be used in numerous technical fields such as in the closed-loop control of a braking force providable by an electromechanical brake or a steering force in a steering system.

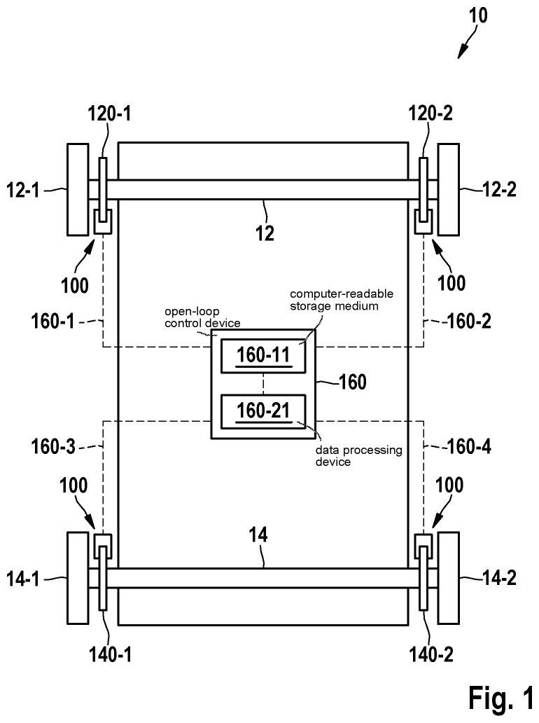

Without limiting the specific application, the method according to the present disclosure is described using a vehicle braking system 100 of a vehicle 10 shown in FIG. 1.

The vehicle braking system 100 can have: on a front axle 12 of the vehicle 10, a first front wheel brake 120-1 assigned to a first front wheel 12-1, and a second front wheel brake 120-2 assigned to a second front wheel 12-2; and on a rear axle 14 of the vehicle 10, a first rear wheel brake 140-1 assigned to a first rear wheel 14-1, and a second rear wheel brake 140-2 assigned to a second rear wheel 14-2. The first front wheel brake 120-1, the second front wheel brake 120-2, the first rear wheel brake 140-1 as well as the second rear wheel brake 140-2 are designed as electromechanical brakes.

The vehicle braking system 100 also has an open-loop control device 160 that is designed to individually control, by means of open-loop/closed-loop control, the first front wheel brake 120-1, the second front wheel brake 120-2, the first rear wheel brake 140-1, as well as the second rear wheel brake 140-2. The open-loop control device 160 can, for example, be in signal exchange communication with the first front wheel brake 120-1, the second front wheel brake 120-2, the first rear wheel brake 140-1 as well as the second rear wheel brake 140-2 in an assigned manner via signal exchange lines 160-1, 160-2, 160-3, 160-4.

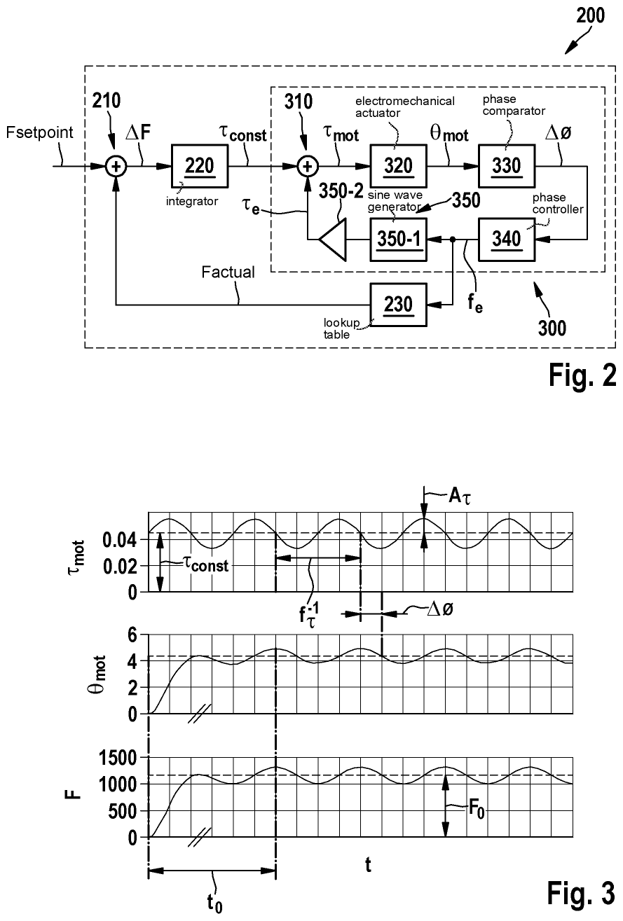

The open-loop control device 160 can, for example, have a computer-readable storage medium 160-11 and a data processing device 160-21. On the storage medium 160-11, a computer program can be stored which includes commands which, when executed by the data processing device 160-21, cause the data processing device 160-21 to execute a method for controlling, by means of open-loop/closed-loop control, the vehicle braking system 100, which is described in detail below by reference to FIG. 2 to 4.

The storage medium 160-11 can, for example, have a random access memory, read-only memory, a hard disk, etc. The data processing device 160-21 can, for example, have a processor, an application-specific integrated circuit (ASIC), and the like. The data processing device 160-21 and thus the open-loop control device 160 can therefore be considered a computer within the meaning of the disclosure.

The open-loop control device 160 can be designed to perform a method for controlling, by means of closed-loop control, the braking force providable by means of one of the brakes 120-1, 120-2, 140-1, 140-2.

An exemplary force control loop 200 is shown in FIG. 2. The closed control loop 200 consists of a first adder 210, an integrator 220, a phase-locked loop 300 as well as a lookup table 230.

The phase-locked loop 300 consists of a second adder 310, an electromechanical actuator 320, a phase comparator 330, a phase controller 340 and an oscillator 350. The electromechanical actuator 320 has an electric motor and can have a rotary-translational gearbox that is designed to convert a rotary motion of a shaft (of a rotor) of the electric motor into a translational motion by which brake pads of an associated vehicle brake can be pressed against a brake drum or brake disk.

During operation, a signal Fₛₑₜₚₒᵢₙₜ is generated during actuation of a brake pedal, which signal corresponds to a target braking force. The signal Fₛₑₜₚₒᵢₙₜ is fed to the first adder 210, in which a signal F_{actual} corresponding to an actual braking force is subtracted from the signal Fₛₑₜₚₒᵢₙₜ. The adder 210 outputs a signal ΔF, which corresponds to a difference between a target force and an actual force, to an integrator 220 which, on the basis of this signal, generates an initial control signal τ_{const} which is fed to the second adder 310 of the phase-locked loop 300. The initial control signal τ_{const} can be a current or voltage signal that corresponds to a torque to be output by the electric motor of the actuator 320.

In the adder 310, a time-varying second control signal τₑ is added to the initial control signal τ_{const}, and the sum signal is output as an actuator control signal τₘₒₜ which is supplied to the electric motor of the electromechanical actuator 320. By supplying the actuator control signal τₘₒₜ, a shaft/rotor of the electric motor is set in rotation.

The curves of the actuator control signal τₘₒₜ, the rotor position θₘₒₜ as well as an actuation force F of the actuator 320 over time t are shown in FIG. 3. The actuator control signal τₘₒₜ is a periodic signal with mean value τ_{const}, amplitude A_{τ}, as well as frequency f_{τ}, i.e., period f_{τ}-1. After a settling time t₀, the rotor position θₘₒₜ has basically the same frequency as the actuator control signal τₘₒₜ and is out of phase in relation to the actuator control signal τₘₒₜ, i.e., between rotor position θₘₒₜ and the actuator control signal, τₘₒₜ, there is a phase difference (a phase shift) Δφ. The actuation force F follows the rotor position θₘₒₜ and, after the settling time t₀, has a periodic progression around a mean value (operating point) F₀.

The phase difference Δφ is frequency-dependent and depends on the flywheel mass of the actuator 320 or of an actuator system comprising the actuator 320 and the stiffness at the operating point F₀. The flywheel mass is determined by the design and can be assumed to be constant.

The rotor position θₘₒₜ can be recorded over time with a sensor provided on the actuator 320, and a signal from the sensor corresponding to the rotor position θₘₒₜ is fed to a phase comparator 330 which is designed to ascertain the phase difference Δφ between the actuator control signal τₘₒₜ and the rotor position θₘₒₜ.

A phase difference signal corresponding to the phase difference Δφ is then fed to a phase controller 340 which is designed to generate, on the basis of the phase difference signal, an oscillator control signal fₑ which is fed to the oscillator 350. The oscillator 350 is designed to generate, on the basis of the oscillator control signal fₑ, the time-varying second control signal τₑ which, as explained above, is fed to the second adder 310.

The oscillator 350 can be designed to generate a periodic second control signal τₑ. This can, for example, ensure a defined phase difference. The oscillator 350 can, as indicated in FIG. 2, comprise: a sine wave generator 350-1 and a downstream amplifier 350-2 which is designed to amplify a sine wave generated by the sine wave generator 350-1 to an amplitude A_{τ}.

With the phase-locked loop 300, the phase difference Δφ between the actuator control signal τₘₒₜ and the rotor position θₘₒₜ can be controlled, by means of closed-loop control, to a desired phase difference, whereby a second control signal τₑ with a desired frequency can be generated by means of the oscillator 350. For example, by controlling, by means of closed-loop control, to a specific phase difference Δφ, the second control signal can be generated with a frequency that is generated with a natural frequency of the actuator 320 or of an actuator system comprising the actuator 320. This ensures a high degree of robustness against parameter variations, such as damping variations, in the actuator or the actuator system.

If the frequency of the second control signal τₑ, i.e., the excitation frequency corresponds to the undamped natural frequency of the actuator system, the phase difference Δφ will be one quarter of a period (i.e., 90° or π/2). The phase controller 340 can be designed to control, by means of closed-loop control, the phase difference Δφ to one quarter of a period. This allows the excitation frequency to be controlled to the undamped natural frequency.

Furthermore, on the basis of the oscillator control signal fₑ, the signal F_{actual} corresponding to an actual braking force is generated and fed to the first adder 210. The signal F_{actual} corresponding to an actual braking force can be generated, for example, on the basis of a lookup table 230, i.e., a table of values, in which a unique relationship between the oscillator control signal and force is stored.

With this method, braking force sensors, which generally can only be installed with increased effort, are not required. Furthermore, a detailed model of the electromechanical actuator 320 is not required. The method does not require knowledge of a force-displacement characteristic curve and is therefore not affected by temperature-related or wear-induced changes to the force-displacement characteristic curve.

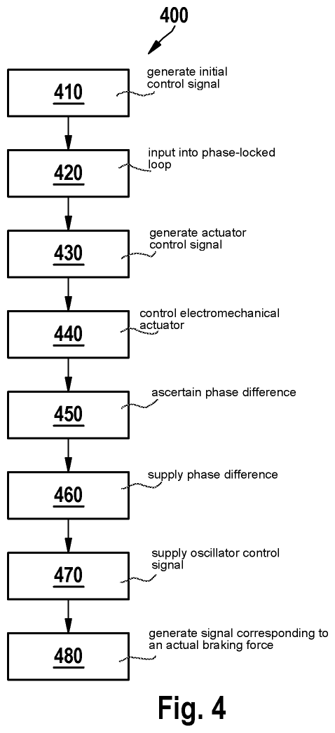

An exemplary method 400 for controlling, by means of closed-loop control, a braking force providable by means of the electromechanical actuator 320 is described below with reference to the flow chart shown in FIG. 4. The method 400 comprises:
generating the initial control signal τ_{const} which corresponds to a deviation between a target force and an actual force ascertained by means of the first adder 210 of the force control loop 200 (410),
inputting the initial control signal τ_{const} into the phase-locked loop 300 (420),
generating the actuator control signal τₘₒₜ by adding a time-varying second control signal τₑ output by the oscillator 350 to the initial control signal τ_{const} by means of the second adder 310 (430),
controlling the electromechanical actuator 320 by means of the actuator control signal τₘₒₜ (440),
ascertaining the phase difference Δφ between the actuator control signal τₘₒₜ and a rotor position θₘₒₜ of the electric motor by means of the phase comparator 330 (450),
supplying the phase difference signal output by the phase comparator 330 and corresponding to the phase difference to the phase controller 340 which is designed to generate an oscillator control signal fₑ on the basis of the phase difference signal (460),
supplying the oscillator control signal fₑ to the oscillator 350 which is designed to generate the time-varying second control signal τₑ on the basis of the oscillator control signal fₑ (470) and
generating a signal F_{actual} corresponding to an actual braking force on the basis of the oscillator control signal fₑ, and supplying the signal to the first adder 210 (480).

What is claimed is:

1. A method for controlling, using closed-loop control, a force providable using an electromechanical actuator having an electric motor, the method comprising the following steps:
generating an initial control signal, which corresponds to a deviation between a target force and an actual force ascertained using a first adder of a force control loop; and
inputting the initial control signal into a phase-locked loop of the force control loop, wherein the phase-locked loop includes:
a second adder,
the electromechanical actuator,
a phase comparator,
a phase controller, and
an oscillator,
wherein the method further comprises:
generating an actuator control signal by adding a time-varying second control signal output by the oscillator to the initial control signal using the second adder,
controlling the electromechanical actuator using the actuator control signal,
ascertaining, using the phase comparator, a phase difference between the actuator control signal and a rotor position of the electric motor,
supplying a phase difference signal output by the phase comparator and corresponding to the phase difference to the phase controller which is configured to generate an oscillator control signal based on the phase difference signal,
supplying the oscillator control signal to the oscillator which is configured to generate the time-varying second control signal based on the oscillator control signal, and
generating a signal corresponding to an actual force based on the oscillator control signal and supplying the signal to the first adder.

2. The method according to claim 1, wherein the signal corresponding to the actual force is generated based on a lookup table.

3. The method according to claim 1, wherein the second control signal is a periodic signal.

4. The method according to claim 1, wherein the oscillator control signal corresponds to a natural frequency of one of: (i) the electromechanical actuator, or (ii) an actuator system including the electromechanical actuator.

5. The method according to claim 4, wherein the phase difference signal corresponds to a phase difference of 90°.

6. The method according to claim 1, wherein the electromechanical actuator is part of an electromechanical vehicle brake and the force is a braking force.

7. A non-transitory computer-readable storage medium on which is stored a computer program for controlling, using closed-loop control, a force providable using an electromechanical actuator having an electric motor, the computer program, when executed by a computer, causing the computer to perform the following steps:
generating an initial control signal, which corresponds to a deviation between a target force and an actual force ascertained using a first adder of a force control loop; and
inputting the initial control signal into a phase-locked loop of the force control loop, wherein the phase-locked loop includes:
a second adder,
the electromechanical actuator,
a phase comparator,
a phase controller, and
an oscillator,
wherein the method further comprises:
generating an actuator control signal by adding a time-varying second control signal output by the oscillator to the initial control signal using the second adder,
controlling the electromechanical actuator using the actuator control signal,
ascertaining, using the phase comparator, a phase difference between the actuator control signal and a rotor position of the electric motor,
supplying a phase difference signal output by the phase comparator and corresponding to the phase difference to the phase controller which is configured to generate an oscillator control signal based on the phase difference signal,
supplying the oscillator control signal to the oscillator which is configured to generate the time-varying second control signal based on the oscillator control signal, and
generating a signal corresponding to an actual force based on the oscillator control signal and supplying the signal to the first adder.

8. A vehicle braking system, comprising:
one or more electromechanical brakes; and
one or more open-loop control devices that are configured to carry out closed-loop control according to a method for controlling, using the closed-loop control, a force providable using an electromechanical actuator having an electric motor, the method including the following steps:
generating an initial control signal, which corresponds to a deviation between a target force and an actual force ascertained using a first adder of a force control loop; and
inputting the initial control signal into a phase-locked loop of the force control loop, wherein the phase-locked loop includes:
a second adder,
the electromechanical actuator,
a phase comparator,
a phase controller, and
an oscillator,
wherein the method further comprises:
generating an actuator control signal by adding a time-varying second control signal output by the oscillator to the initial control signal using the second adder,
controlling the electromechanical actuator using the actuator control signal,
ascertaining, using the phase comparator, a phase difference between the actuator control signal and a rotor position of the electric motor,
supplying a phase difference signal output by the phase comparator and corresponding to the phase difference to the phase controller which is configured to generate an oscillator control signal based on the phase difference signal,
supplying the oscillator control signal to the oscillator which is configured to generate the time-varying second control signal based on the oscillator control signal, and
generating a signal corresponding to an actual force based on the oscillator control signal and supplying the signal to the first adder;
wherein the electromechanical actuator is part of an electromechanical vehicle brake of the one or more electromechanical vehicle brakes, and the force is a braking force.

9. The vehicle braking system according to claim 8, further comprising a central open-loop control device which is configured to control, using losed-loop control, a plurality of the electromechanical brakes or all of the electromechanical brakes.

10. A vehicle, comprising:
a vehicle braking system, including:
one or more electromechanical brakes; and
one or more open-loop control devices that are configured to carry out closed-loop control according to a method for controlling, using the closed-loop control, a force providable using an electromechanical actuator having an electric motor, the method including the following steps:
generating an initial control signal, which corresponds to a deviation between a target force and an actual force ascertained using a first adder of a force control loop; and
inputting the initial control signal into a phase-locked loop of the force control loop, wherein the phase-locked loop includes:
a second adder,
the electromechanical actuator,
a phase comparator,
a phase controller, and
an oscillator,
wherein the method further comprises:
generating an actuator control signal by adding a time-varying second control signal output by the oscillator to the initial control signal using the second adder,
controlling the electromechanical actuator using the actuator control signal,
ascertaining, using the phase comparator, a phase difference between the actuator control signal and a rotor position of the electric motor,
supplying a phase difference signal output by the phase comparator and corresponding to the phase difference to the phase controller which is configured to generate an oscillator control signal based on the phase difference signal,
supplying the oscillator control signal to the oscillator which is configured to generate the time-varying second control signal based on the oscillator control signal, and
generating a signal corresponding to an actual force based on the oscillator control signal and supplying the signal to the first adder;
wherein the electromechanical actuator is part of an electromechanical vehicle brake of the one or more electromechanical vehicle brakes, and the force is a braking force.
